(19) United States
(12) Patent Application Publication
(10) Pub. No.: US 2009/0278672 A1
(43) Pub. Date: Nov. 12, 2009

(54) Driver assistance system having a device for recognizing stationary objects

(76) Inventors: Michael Weilkes, Dickhozen (DE); Juergen Boecker, Stuttgart (DE); Peter Petschnigg, Stuttgart (DE)

Correspondence Address: KENYON & KENYON LLP, ONE BROADWAY, NEW YORK, NY, 10004, US

(21) Appl. No.: 11/918,413

(22) PCT Filed: Mar. 16, 2006
(86) PCT No.: PCT/EP2006/060810

§ 371 Date: Jan. 27, 2009

(30) Foreign Application Priority Data
Apr. 15, 2005 (DE) 10 2005 017 422.1

(51) Int. Cl. B60Q 1/00

(52) U.S. Cl. 340/435

(57) ABSTRACT

A driver assistance system for motor vehicles, having a localization system for localizing objects in the surroundings of the vehicle and having a device for recognizing stationary objects by comparing the difference between the relative motion of the object and the inherent motion of the vehicle with a threshold value, wherein the device is embodied to vary the threshold value as a function of variables that influence the accuracy with which the relative and inherent motions are determined.

### RELATED APPLICATION INFORMATION

The present application claims the benefit of International Patent application no. PCT/EP2006/060810, which was filed on Mar. 16, 2006, and which claims priority to and the benefit of German patent application no. DE 102005017422.1, which was filed in Germany on Apr. 15, 2005, the disclosures of which are both hereby incorporated by reference.

### FIELD OF THE INVENTION

The present invention relates to a driver assistance system for motor vehicles, having a localizing system for localizing objects in the vehicle's surroundings, and having a device for comparing the difference between the relative motion of the object and the inherent motion of the vehicle with a threshold value.

### BACKGROUND INFORMATION

Driver assistance systems serve to assist the driver when operating a motor vehicle, to warn him or her of impending hazards, and/or to automatically initiate actions to mitigate the consequences of an imminent collision. The driver assistance system draws for that purpose on data of a localizing system, with which objects in the vehicle's surroundings, in particular other traffic participants, can be detected. Examples of such driver assistance systems are lane departure warning systems, which inform the driver if he or she is about to leave, without signaling, the lane in which he or she is presently traveling; or adaptive cruise control (ACC) systems, which automatically regulate the velocity of the own vehicle so that a detected preceding vehicle is followed at an appropriate distance.

Radar systems, e.g. long-range (77 GHz) radar systems, are usually used at present as the localizing system. Also conceivable, however, is the use of ultrasonic sensors, mono or stereo video systems, short-range (24 GHz) radar systems, or lidar systems.

The ACC systems that are already in practical use today are generally designed for use on expressways or well-constructed main roads, and therefore react in principle only to moving objects, e.g. to preceding vehicles, while stationary objects are ignored, proceeding from the assumption that on expressways such objects are normally not located on the roadway, and because it is technically very difficult to perform a relevance classification of stationary objects on the basis of radar data. But because stationary objects also cause a radar echo, the system must be capable of distinguishing between stationary objects and moving objects.

Also under development are ACC systems that have expanded applicability and can be also be used, for example, on main roads or even in city traffic, or even as a traffic-jam assistant in slow-traffic situations. These advanced systems make large demands in terms of interpretation of the traffic environment, so that the distinction between (relevant) stationary and moving objects, and between objects that are fundamentally movable and non-movable, plays a considerable role, for example for recognizing bicyclists or pedestrians and predicting their behavior. The “stationary” and “moving” states refer to the instantaneous state of the object. The classification as “non-movable” means that an object has never moved since entering the sensing region of the localizing system, and an object is considered “movable” if it has moved in the past. For example, a vehicle that is stopped can be recognized by the fact that it is classified as stationary and movable. In the simplest case the classification refers only to motion in one direction, i.e. in the travel direction, but in more-complex systems it can also refer to transverse motions.

With a radar system, the relative velocity of an object can be directly measured in the direction of the viewing beam, i.e. approximately in the travel direction. The absolute velocity of the object, i.e. the “ground speed,” is then obtained by subtracting the known inherent velocity of the own vehicle from the measured relative velocity (strictly speaking, the apparent relative motion resulting from the motion of the own vehicle is subtracted). If this difference is zero, the object is a stationary one. In practice, however, a difference of exactly zero is never obtained even for stationary objects, because of unavoidable measurement inaccuracies. The difference is therefore compared with a suitably selected threshold value, and the object is classified as stationary if the absolute value of the velocity difference is below the threshold value.

With greater demands in terms of the accuracy of object classification, however, it becomes difficult to select a suitable threshold value. If the threshold value is too low, inaccuracies in the velocity measurements made with the aid of the localizing system—and, for the own vehicle, with the aid of a rotation-speed measuring device and a yaw rate sensor in the case of transverse motions—can result in misclassifications. This is particularly problematic when a classification as to movable and non-movable objects is also necessary, since once an object has been incorrectly classified as moving, from that time onward it is always considered movable. If too high a threshold value is selected, however, objects moving at low speed, for example pedestrians, are classified as stationary.

Misclassifications occur particularly frequently in situations in which dynamics are high, for example when braking heavily or traveling in tight curves. In such cases, in particular, the own-vehicle velocity measurement is distorted by filter transit times and other filter effects such as signal delays, under- and overshoots, and the like. Inaccuracies in measurements made with the localizing system are a further source of errors. Additional error sources result from the fact that in most cases different filters or filter algorithms are used for processing the data from various sensor systems, so that, for example, different signal delays simulate differences that do not actually exist. This problem becomes worse when, for more-accurate sensing of the traffic environment, a plurality of sensor systems are used whose measurement results are then fused with one another.

These shortcomings prove particularly disruptive in city traffic or in general for low-speed driving, i.e. in situations in which the refined driver assistance systems are intended to be used. On the one hand, particularly high dynamics are present especially in city traffic, increasing the probability of misclassifications; on the other hand, in city traffic a reliable differentiation between stationary but movable objects (e.g. stopped vehicles) and non-movable objects (e.g. utility covers on the roadway) is particularly important, since stationary vehicles must also be reacted to in city traffic. A further complicating factor is that the own-vehicle velocity measurement becomes very inaccurate specifically at very low speeds. The own-vehicle velocity is usually calculated on the basis of wheel rotation speeds, which are measured with pulse generators. At a low rotation speed, the pulse frequency of these pulse generators is so low that an accurate velocity measurement is no longer possible.

Driver assistance systems are intended not only to objectively increase driving safety, but also to give the driver an increased subjective feeling of safety, and to improve vehicle operating convenience. This being the case, it is important to make the behavior of the driver assistance system plausible and comprehensible to the driver at all times. In this context, the inherently desirable fact that the localizing system can sense the absolute and relative motions of objects much more accurately than the driver him- or herself can estimate those motions turns out to be a disadvantage in certain circumstances, especially in situations in which an acute hazard is not yet present. Specifically, if the driver assistance system, because of the high sensitivity of its sensor suite, behaves differently than the driver would expect based on his or her limited perception capabilities, the system's behavior is implausible from the driver's point of view; this is often felt to be irritating, and interferes with acceptance of the driver assistance system.

### SUMMARY OF THE INVENTION

The exemplary embodiments and/or the exemplary methods of the present invention having the features described herein offers the advantage that it makes possible, with regard to differentiation between stationary and moving objects, a system behavior that is more situationally appropriate and/or more comprehensible to the driver.

This is achieved, according to the exemplary embodiments and/or the exemplary methods of the present invention, in that the threshold value with which the difference between relative motion and own-vehicle motion is compared is varied in situationally dependent fashion, specifically as a function of one or more variables that influence the accuracy of the determination of the relative and own-vehicle motions.

It is thus possible, in situations in which the data furnished by the localizing system regarding the own-vehicle motion and relative motion are highly reliable, to lower the threshold value so that a sharper distinction can be made between stationary and moving objects; whereas on the other hand, as the uncertainty of the data rises, the threshold value is increased in order to prevent misclassifications. The limited perceptual capability of the driver can likewise be better taken into account by varying the threshold value.

Advantageous embodiments and refinements of the exemplary embodiments and/or the exemplary methods of the present invention are evident from the further disclosures herein.

The variables that influence the accuracy with which the relative motion and own-vehicle motion are determined with the aid of the localizing system, and that are therefore incorporated into the calculation of the threshold value, may be one or more of the following variables: the standard deviation of the measured relative velocity of the object, the acceleration of the own vehicle, the own-vehicle velocity, and variables that specify the yawing motion of the own vehicle.

According to an embodiment, a classification of the localized objects as to stationary and moving objects is performed not only in the travel direction, but also for the motion components in the transverse direction. For that purpose, a separate threshold value may be created for each of the two motion components. The standard deviation for measurement of the relative velocity of the object in the transverse direction, and the measured object distance, may then also be incorporated into the calculation of the threshold value for the transverse components.

For a sufficiently accurate, situationally appropriate adaptation of the threshold value or values, it is generally sufficient if the threshold value is calculated as a linear combination of the various influencing variables, which may be with the addition of an additive constant that accounts for the remaining residual uncertainties if all the influencing variables have a value of zero.

According to an advantageous refinement, a classification is performed not only as to stationary and moving objects, but also as to movable and non-movable objects. An object is classified as movable only if it was classified as moving in a specific number of successive measurement cycles. The number of measurement cycles necessary for this purpose is correlated in particular with the dimensioning of the threshold values as a function of the standard deviations for the relative velocities.

Alternatively or additionally, the determination of the threshold value can also take into account how accurately the driver him- or herself can estimate the motion of the pertinent object. Relevant influencing variables in this case are, for example, the object distance and the velocity of the own vehicle, since the greater the distance of an object and the higher the velocity of the driver's own vehicle, the more difficult it is for him or her to estimate the object's motion.

Exemplary embodiments of the present invention are depicted in the drawings and explained in more detail in the description that follows.

### BRIEF DESCRIPTION OF THE DRAWINGS

FIG. 1 shows a sketch of a motor vehicle equipped with a driver assistance system, and a localized object.

FIG. 2 shows a block diagram of those portions of the driver assistance system that refer to classification of the object as moving, stationary, movable, or not movable.

FIG. 3 shows a block diagram of a driver assistance system according to another exemplifying embodiment.

FIG. 4 shows a diagram to explain the manner of operation of the driver assistance system according to FIG. 3.

FIG. 5 shows another diagram to further explain the manner of operation of the driver assistance system according to FIG. 3.

FIG. 6 shows another diagram to further explain the manner of operation of the driver assistance system according to FIG. 3.

### DETAILED DESCRIPTION

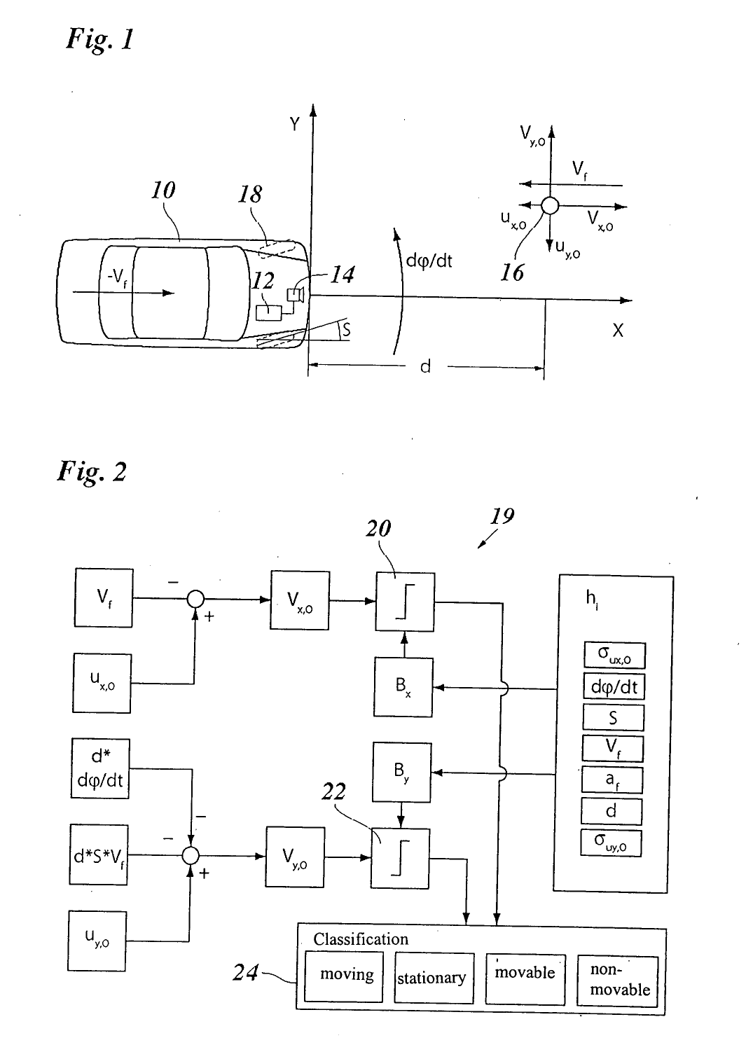

FIG. 1 depicts a vehicle 10 that is equipped with a driver assistance system 12, for example an ACC system. A radar sensor 14 is built in as a localization system. In the example shown, a single object 16, whose distance d in direction X (travel direction of vehicle 10) and relative velocity u_{x,O} in the X direction can be measured directly, is located in the localization region of the radar sensor. Radar sensor 12 has a certain angular resolution capability and can therefore also measure the azimuth angle at which object 16 is being viewed with respect to the X axis. From this, the transverse position of the object in the direction of the Y axis can be calculated with the aid of the measured distance d, and the relative velocity u_{y,O} in the Y direction can be calculated by time derivation.

Appearing below object 16 in FIG. 1 is a vector V_{f} that indicates the “inherent velocity” of vehicle 10. More precisely, this vector indicates the apparent relative velocity that would result, for an object at rest, from the inherent motion of vehicle 10 in the travel direction (positive X direction). The “actual inherent velocity” of vehicle 10 is depicted, once again as a vector, within the outline of the vehicle, and is labeled −V_{f}. The own-vehicle velocity V_{f} is measured directly with the aid of usual sensors (not shown) on board vehicle 10. Subtracting the own-vehicle velocity V_{f} from the relative velocity u_{x,O} of object 16 yields the absolute velocity V_{x,O} of object 16.

The inherent velocity of vehicle 10 has, by definition, no component in the Y direction, since the X axis of the coordinate system is defined here by the longitudinal axis of the vehicle. If the absolute velocity V_{y,O} of object 16 in the Y direction is to be calculated, however, a possible yawing motion of vehicle 10 about its vertical axis must be taken into account, since that motion results in an apparent change in the azimuth angle of object 16 and thus in an apparent relative velocity in the Y direction. In FIG. 1, the yaw velocity d[φ]/dt of vehicle 10 is symbolized by a curved arrow. This yaw velocity can be measured directly with the aid of a yaw rate sensor (not shown). Alternatively or additionally, it is also possible to calculate the yaw velocity from the measured steering input S of front wheels 18 of the vehicle and the absolute value of the own-vehicle velocity V_{f}. The absolute velocity V_{y,O} of object 16 in the Y direction is then obtained using the formula

V_{y,O}=u_{y,O}−d*d[φ]/dt.

FIG. 2 is a block diagram depicting a device 19 for calculating the absolute velocities V_{x,O} and V_{y,O} of object 16 from the measured data, and for recognizing stationary objects. For calculation of the transverse component V_{y,O}, it is assumed here that the two above-described methods for measuring yaw velocity are applied in parallel, and a weighted sum is calculated from the results.

In order to decide whether object 16 is to be classified as a stationary or a moving object, the absolute velocities V_{x,O} and V_{y,O} are respectively delivered to an associated threshold value comparator 20, 22 and compared with a respective suitable threshold value Bₓ, B_{y}. The comparison results are delivered to a classification unit 24, and the object is classified as stationary if the two absolute velocities are below their respective threshold values, and otherwise as moving.

In the driver assistance system described here, the threshold values Bₓ and B_{y} are not static, but are varied dynamically as a function of a number of variables, here referred to in combination as hᵢ. The individual variables involved are: the standard deviations [σ]_{ux,O} and [σ]_{uy,O} for measurements of the relative velocities of object 16 in the X and Y directions, the yaw velocity d[σ]/dt (obtained by direct measurement) of vehicle 10, the acceleration a_{f} of vehicle 10, the steering input S, the inherent velocity V_{f} of vehicle 10, and the measured distance d of object 16.

The standard deviations [σ]_{ux,O} and [σ]_{uy,O} are obtained from the properties of the sensors and measurement method being used, and can be calculated experimentally or on the basis of suitable sensor models. Also conceivable is a determination of the standard deviations by statistical evaluation of the data acquired in successive measurement cycles. These standard deviations provide an indication of the reliability of the measured relative velocities. High standard deviations therefore result in an increase in the threshold values Bₓ and B_{y}.

The other variables grouped under the collective designation hᵢ also influence, in specific ways, the accuracy with which the absolute velocities of object 16 can be calculated. Because the distance d and also (as a rule) the standard deviations can be different for various objects, it is understood that in the case of multiple localized objects, the threshold values Bₓ and B_{y} are calculated separately for each object, in each case using the variables hᵢ applicable to that object.

The threshold values Bₓ and B_{y} are calculated, for example, using the following functional procedure:

Bₓ=B_{min,x}+f_{σx}*[σ]_{ux,O}+f_{a,x}*|a_{f}|+f_{v,x}*|V_{f}|+f_{g,x}*g

B_{y}=B_{min,y}+f_{σ,y}*[σ]_{uy,O}+f_{d,y}*d+f_{v,y}*|V_{f}|+f_{g,y}*g,

in which B_{min,x} and B_{min,y} are predefined minimum values below which the threshold does not fall. This takes into account unavoidable residual errors that can result, for example, from inaccuracies in the measurement of own-vehicle velocity V_{f} but also from filter transit times that lead to delays in adapting variables hᵢ, for example in a context of large accelerations. The coefficients f . . . with the various indices are constant coefficients that determine how strongly the respectively pertinent variable hᵢ influences the threshold value. The factor g represents the yaw velocity, which on the one hand is measured directly and on the other hand is calculated from the steering input S, and is defined by the formula:

g=MAX(d[φ]/dt,fₛ*S*V_{f})

using a suitably selected coefficient fₛ so that the product fₛ*S*V_{f} is approximately proportional to the yaw velocity. This alternative method for calculating the yaw velocity could also be dispensed with, but it has the advantage that a change in steering input S can often be measured more quickly than the change in yaw velocity determined with the aid of a yaw rate sensor.

In addition to cornering situations, large accelerations and decelerations also represent a substantial source of error. The coefficient f_{a,x} correspondingly has a relatively high value. The influence of the own-vehicle velocity V_{f} on the accuracy of the determination of the object's absolute velocity is, in contrast, comparatively minor, so that the coefficients f_{v,x} and f_{v,y} have only relatively low values here.

The coefficients f_{σ,x} and f_{σ,y} should be equal to approximately 1.0. If it is assumed that the distribution of the measurement results for the absolute velocities u_{x,O} and u_{x,O} corresponds approximately to a Gaussian distribution, approximately 67% of all the measurements lie within one standard deviation, so that if the threshold value is raised and lowered in accordance with the standard deviation, a misclassification is caused in approximately 33% of the cases. This is acceptable for classification of the objects as “moving” or “stationary,” since this classification applies only temporarily and can be corrected again in the next measurement cycle. The objects are, however, also classified in classification unit 24 according to the categories “movable” and “non-movable.” The classification as “movable” is practically irrevocable, since an object is considered movable as soon as it has been classified once as a moving object. To further reduce the frequency of misclassifications, classification unit 24 is therefore embodied so that an object is classified as movable only if it has consistently been classified as “moving” in a predetermined number of (e.g. five) successive measurement cycles. For an error frequency of 33% per measurement cycle, the overall error frequency is then reduced to an acceptable value of only approximately 0.4%. A very reliable classification of the objects can thus be achieved by dynamic adaptation of the threshold values Bₓ and B_{y}.

In the example shown, Bₓ and B_{y} are linear functions of the variables hᵢ. In a modified embodiment, however, it is also conceivable to use nonlinear functions that reflect even better how the optimum threshold values depend on the influencing variables.

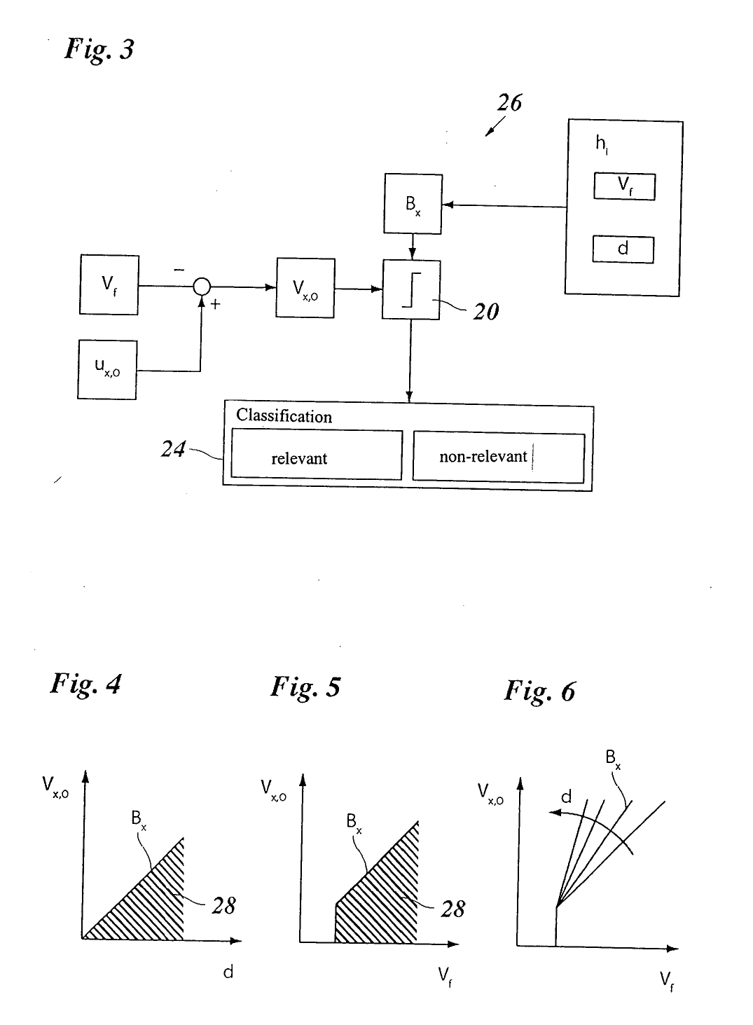

FIG. 3 is a block diagram of a device 26 that corresponds, in terms of its function, to device 19 in FIG. 2 but has only a limited functionality. The emphasis here is on taking into account the human driver's abilities to perceive and estimate, in order to better adapt the system's behavior to the driver's intuitive expectations.

In this simple example, the only variables hᵢ are the inherent velocity V_{f} of vehicle 10 and the distance d of the relevant object. These variables serve to determine the threshold value Bₓ for threshold value comparator 20. In this case the objects are classified by classification unit 24 according to only two categories, namely as either “relevant” or “not relevant.” If the absolute velocity V_{x,O} of the object is below the threshold value Bₓ, the object is classified as not relevant, so that this object does not trigger any system reaction in the context of the ACC function.

FIG. 4 is a diagram illustrating the dependence of the threshold value Bₓ on the object distance d. The shaded region 28 corresponds to the value pairs (d, V_{x,O}) for which the object is categorized as not relevant. It is apparent that the threshold value Bₓ is increased linearly with increasing object distance d.

One example that might be imagined is a situation in which the object is a vehicle by the roadside, partly protruding into the own vehicle's lane, that is about to come to a stop and is still moving, or conversely is about to drive off and is already starting to move. For a large object distance d this small motion is still not perceptible to the driver, and if the ACC system were already to react to this vehicle, the reaction would not be plausible to the driver. The variable threshold value Bₓ ensures that this implausible behavior is avoided. As the distance d continues to decrease, for example in the case of an object just beginning to move, and the absolute velocity V_{x,O} of the object simultaneously increases, the driver will also recognize that the supposedly stationary vehicle is about to merge into the flow of traffic. In the d, V_{x,O} diagram of FIG. 4, the object moves up and to the left and will soon exceed the threshold value Bₓ, so that the corresponding system reaction is triggered but is now perceptible and plausible for the driver.

FIG. 5 illustrates the dependence of the threshold value Bₓ on the inherent velocity V_{f} of vehicle 10. For a very low own-vehicle velocity V_{f}, the threshold value Bₓ is practically equal to zero, i.e. the system reacts to even the slightest motion of the localized object. This is based on the consideration that the driver of the own vehicle can also very easily detect motions of other vehicles if his or her own vehicle is almost stationary. In the situational example discussed above, the ACC system would categorize the vehicle that is just driving off as “relevant,” and react by decelerating the own vehicle. This also corresponds to the natural behavior of a “friendly” automobile driver, who in this situation would also slow down in order to allow the accelerating vehicle to merge.

In the example shown, above a certain minimum value for the own-vehicle velocity V_{f}, the threshold value increases abruptly to a base value and then rises linearly as the own-vehicle velocity increases further. This takes into account the fact that the driver of the own vehicle has more and more difficulty recognizing the motion of the object as his or her own-vehicle velocity V_{f} increases.

FIG. 6 depicts a three-dimensional characteristics diagram indicating the dependence of the threshold value Bₓ on the own-vehicle velocity V_{f} and object distance d. As the object distance d increases, the curve indicating the threshold value Bₓ as a function of V_{f} becomes steeper, i.e. for a given V_{f}, the threshold value rises (as in FIG. 4) with increasing object distance d.

It is understood that the velocity scale for V_{x,O} is greatly spread out in FIGS. 4 to 6, i.e. it encompasses only velocities which are so low that the driver is uncertain as to whether or not the object is moving. In practice, the threshold value Bₓ (at least as a function of V_{f}) will rise only to a certain maximum value, so that objects clearly perceived by the driver as moving objects are also categorized by as relevant by classification device 24. This maximum value can, in turn, once again be dependent on the object distance, thus ensuring that real obstacles trigger a prompt and appropriate system reaction in every case.

The system depicted in FIGS. 3 through 6 can of course also be combined with the systems depicted in FIG. 2, for example by suitable (dynamic) modification of the coefficient f_{v,x} and insertion of a distance-dependent term into the functional procedure for Bₓ.

1-14. (canceled)

15. A driver assistance system for a motor vehicle, comprising:
a localization system for localizing objects in the surroundings of the vehicle; and
a comparing device for comparing a difference between a relative motion of an object and an inherent motion of the vehicle with a threshold value, wherein the device is configured to vary the threshold value as a function of variables that influence an accuracy with which the relative motion and the inherent motion are determined.

16. The driver assistance system of claim 15, wherein the variables, on the basis of which the threshold value is varied, encompass variables that influence the accuracy with which the relative motion and the inherent motion are determinable with the localization system.

17. The driver assistance system of claim 16, wherein the variables encompass at least one of the following variables: a standard deviation upon measurement of a relative velocity of the object in a travel direction of the vehicle, an acceleration of the vehicle, a yaw velocity of the vehicle, and an inherent velocity of the vehicle.

18. The driver assistance system of claim 16, wherein the device is configured to calculate, on the basis of the relative motion of the object and the inherent motion of the vehicle, the absolute velocity of the object in the travel direction of the vehicle and in a transverse direction, and to compare them respectively to a threshold value that is dependent on the variables.

19. The driver assistance system of claim 17, wherein the variables encompass a measured distance of the object and the standard deviation for measurement of the relative velocity in the transverse direction.

20. The driver assistance system of claim 17, wherein the device is configured to determine two yaw velocities by direct evaluation of the signal of (i) a yaw rate sensor and (ii) a steering angle, and wherein one of the variables for calculation of the threshold value is a maximum of the two yaw velocities.

21. The driver assistance system of claim 15, wherein the threshold value is a linear combination of the variables, with the addition of a minimum threshold value.

22. The driver assistance system claim 21, wherein the threshold value Bₓ for the motion in the travel direction is defined by:
Bₓ=B_{min,x}+f_{σ,x}*[σ]_{ux,O}+f_{a,x}*|a_{f}|+f_{v,x}*|V_{f}|+f_{g,x}*g,
where B_{min,x} is the minimum threshold value, [σ]_{ux,O} the standard deviation, a_{f} the acceleration of the vehicle, V_{f} the inherent velocity of the vehicle, and g the yaw velocity, and f_{σ,x}, f_{a,x}, f_{v,x}, and f_{g,x} are predefined coefficients.

23. The driver assistance system of claim 19, wherein the threshold value B_{y} for motion in the transverse direction is defined by:
B_{y}=B_{min,y}+f_{σ,y}*[σ]_{uy,O}+f_{d,y}*d+f_{v,y}*|V_{f}|+f_{g,y}*g,
where B_{min,y} is the minimum threshold value, [σ]_{uy,O} the standard deviation in the transverse direction, and d the distance of the object, and f_{σ,y}, f_{d,y}, f_{v,y}, and f_{g,y} are predefined coefficients.

24. The driver assistance system of claim 15, wherein the device includes a classification device for classification of the objects into moving objects and stationary objects, and for classification into movable objects and non-movable objects, an object being classified as movable only if it has consistently been classified as “moving” in a specific number of successive measurement cycles.

25. The driver assistance system of claim 15, wherein the variables, on the basis of which the threshold value is varied, encompass variables that influence an accuracy with which the relative motion and absolute motion of the object can be estimated by a driver of the vehicle.

26. The driver assistance system of claim 25, wherein the device includes a classification device for classification of the objects into relevant objects and non-relevant objects.

27. The driver assistance system of claim 25, wherein the threshold value rises with increasing object distance.

28. The driver assistance system of claim 25, wherein the threshold value rises with increasing inherent velocity of the vehicle.
